(19) United States
(12) Patent Application Publication
(10) Pub. No.: US 2018/0225289 A1
(43) Pub. Date: Aug. 9, 2018

(54) AUDIO/VIDEO FILE PLAYBACK METHOD AND AUDIO/VIDEO FILE PLAYBACK APPARATUS

(71) Applicant: AutoChips Inc., Hefei (CN)

(72) Inventor: Shuhui ZHANG, Hefei (CN)

(21) Appl. No.: 15/857,640

(22) Filed: Dec. 29, 2017

(30) Foreign Application Priority Data
Feb. 6, 2017 (CN) 201710066178.X

(51) Int. Cl. G06F 17/30; G06F 3/0482

(52) U.S. Cl. CPC G06F 17/3005; G06F 3/0482

(57) ABSTRACT

The present disclosure discloses a method for playing an audio/video file. The method includes: analyzing an audio/video file according to the file type of the audio/video file to obtain a menu metadata of the audio/video file, and storing the menu metadata; analyzing an instruction of an interaction menu to determine the menu metadata corresponding to the instruction of the interaction menu; and determining whether to switch to and play at least one of the audio/video titles as well as the subtitles mapped by the instruction of the interaction menu basing on the menu metadata corresponding to the instruction of the interaction menu. Through the above-mentioned method, the present disclosure is capable of playing audio/video files including multiple independent audio/video titles and/or subtitles according to a user's selection under the GStreamer multimedia playback framework.

### CROSS REFERENCE TO RELATED APPLICATIONS

This application claims priority to Chinese Patent Application No. 201710066178.X, filed Feb. 6, 2017, which is hereby incorporated by reference herein as if set forth in its entirety.

### TECHNICAL FIELD

Embodiments of the present disclosure generally relate to audio/video playback, and in particular relate to an audio/video file playback method and an audio/video file playback apparatus.

### BACKGROUND

GStreamer is an open source multimedia framework library. With GStreamer, a series of media processing modules which include the simple Ogg playback function to the complex audio (mixing) and video (non-linear editing) processing can be built, wherein Ogg is a free and open container format which is maintained by Xiph.Org foundation. The name “Ogg” originates from “ogging”, which is the jerk of the computer game Netrek, which means the strong execution of something while the loss of future resources may not take into account. Whereby, application programs can utilize decoding and filtering techniques in a transparent manner, and developers can use a simple and generic interface to add a new decoder or filter by composing a simple plug-in.

A DivXMenu file includes a multi-level menu, which is available for user to select. In Linux platform, many manufacturers adopt GStreamer multimedia playback framework. The existed Audio Video Interleaved (AVI) plug-in in GStreamer merely supports the playback of the first video in the DivXMenu file or an ordinary AVI/DivX file (merely includes one audio/video), and does not support the playback of other titles of videos in a DivXMenu file with multiple audios and videos according to user's selection.

### SUMMARY

The technical problem which the present disclosure mainly solves is to provide an audio/video file playback method and an audio/video file playback apparatus capable of playing audio/video files including multiple independent audio/video titles and/or subtitles according to a user's selection under the GStreamer multimedia playback framework.

In order to solve the above-mentioned technical problems, a technical scheme adopted by the present disclosure is to provide a method for playing an audio/video file, wherein the audio/video file comprises a plurality of independent audio/video titles and/or subtitles, the audio/video file is played based on a GStreamer multimedia playback framework, the method comprising: determining the file type of the audio/video file and sending a message to notify an upper layer application; analyzing the audio/video file according to the file type of the audio/video file to obtain a menu metadata of the audio/video file and storing the menu metadata; analyzing an instruction of an interaction menu to determine the menu metadata corresponding to the instruction of the interaction menu, wherein the interaction menu comprises a multi-level menu; and determining whether to switch to and play the audio/video titles and/or subtitles mapped by the instruction of the interaction menu basing on the menu metadata corresponding to the instruction of the interaction menu.

An advantageous effect of the present disclosure is that, in contrast to the prior art, the playback method and the playback apparatus of the audio/video file of the present disclosure analyze the audio/video file according to the file type of the audio/video file to obtain the menu metadata of the audio/video file and store the menu metadata, analyze the instruction of the interaction menu to determine the menu metadata corresponding to the instruction of the interaction menu, and determine whether to switch to and play the audio/video titles and/or subtitles mapped by the instruction of the interaction menu basing on the menu metadata corresponding to the instruction of the interaction menu. In this way, the present disclosure is capable of playing audio/video files including multiple independent audio/video titles and/or subtitles according to a user's selection under the GStreamer multimedia playback framework.

### BRIEF DESCRIPTION OF THE DRAWINGS

FIG. 1 is a flow chart of an embodiment of a playback method of an audio/video file of the present disclosure.

FIG. 2 is a schematic diagram of an example of a menu and a title in an audio/video file of a playback method of an audio/video file of the present disclosure.

FIG. 3 is a flow chart of another embodiment of a playback method of an audio/video file of the present disclosure.

FIG. 4 is a flow chart of still another embodiment of a playback method of an audio/video file of the present disclosure.

FIG. 5 is a schematic diagram of the structure of an embodiment of an audio/video file playback apparatus of the present disclosure.

FIG. 6 is a schematic diagram of the structure of another embodiment of an audio/video file playback apparatus of the present disclosure.

FIG. 7 is a schematic diagram of an audio/video file playback apparatus integrated as a component in a GStreamer multimedia framework in an embodiment of the present disclosure.

FIG. 8 is a schematic diagram of an audio/video file playback apparatus placed in a playback application program in an embodiment of the present disclosure.

### DETAILED DESCRIPTION

For a thorough understanding of the present disclosure, numerous specific details are set forth in the following description for purposes of illustration but not of limitation, such as particularities of system structures, interfaces, techniques, et cetera. However, it should be appreciated by those of skill in the art that, in absence of these specific details, the present disclosure may also be carried out through other implementations. In other instances, a detailed description of well-known devices, circuits, and methods is omitted, so as to avoid unnecessary details from hindering the description of the disclosure.

The present disclosure will now be described in detail with reference to the accompanying drawings and the embodiments.

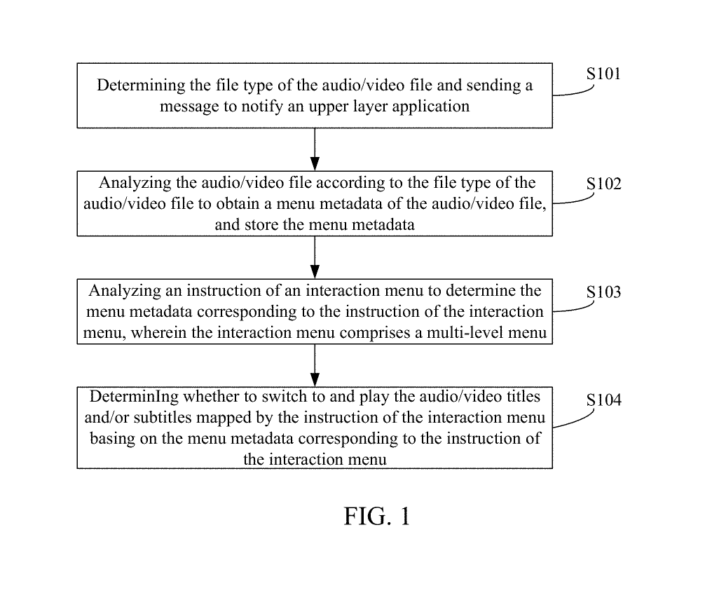

Referring to FIG. 1, a flow chart of an embodiment of a playback method of an audio/video file of the present disclosure is depicted. In an embodiment of the present disclosure, an audio/video file includes multiple independent audio/video titles and/or subtitles, such that a user can select the video titles to be played and the subtitles to be displayed.

The audio/video file is played based on a GStreamer multimedia playback framework. GStreamer is an open source multimedia framework library. With GStreamer, a series of media processing modules which include the simple Ogg playback function to the complex audio (mixing) and video (non-linear editing) processing can be built, whereby application programs can utilize decoding and filtering techniques in a transparent manner, and developers can use a simple and generic interface to add a new decoder or filter by composing a simple plug-in. The manufacturers of many platforms adopt GStreamer because of the above-mentioned advantages of GStreamer. However, in some platforms such as Linux platform, the existed AVI plug-in in GStreamer merely supports the playback of the first video in the DivXMenu file or an ordinary AVI/DivX file (merely includes one audio/video), and does not support the playback of other titles of videos in a DivXMenu file with multiple audio/video according to the user's selection.

The audio/video file playback method of the present disclosure is capable of playing audio/video files including multiple independent audio/video titles and/or subtitles according to the user's selection under the GStreamer multimedia playback framework. It should be noted that the audio/video file playback method of the present disclosure is not limited by the operating system platform as long as the operating system platform utilizes the GStreamer multimedia playback frame.

For purposes of illustration, the method is illustrated as being sequential. However, portions of the method may be performed in other orders or in parallel (e.g., simultaneously). The method may include the following blocks.

In block S101, the file type of an audio/video file is determined, and a message is sent to notify an upper layer application.

Different audio/video file types usually correspond to different file suffixes. Hence, the file type of an audio/video file can be determined according to the file suffix of the audio/video file. If the audio/video file is not suffixed, the file type of the audio/video file can also be obtained by checking the extension name of the audio/video file. Of course, other methods can also be utilized, for instance, reading the file format header information, etc.

When the upper layer application is going to play the audio/video file, the file type of the audio/video file can be determined, and the file type of the audio/video file can be sent to the upper layer application in the form of a message, thereby responding to the inquiry of the upper layer application.

In block S102, the audio/video file is analyzed according to the file type of the audio/video file to obtain a menu metadata of the audio/video file, and the menu metadata is stored.

All the data in a file system is divided into data and metadata. The data refers to the actual data in a general file, while the metadata refers to the system data used to describe the characteristics of a file, for example, access rights, file owners, and file data block distribution information (e.g., inode), etc. When the user manipulates a file, the metadata of the file have to be obtained first, then the location of the file can be located, and the contents or the associated properties of the file can be obtained.

Different audio/video file types are different in the encapsulation format of files. After obtaining the file type of the audio/video file, the audio/video file can be analyzed according to the encapsulation format of the file type, and then the menu metadata of the audio/video file obtained by the analysis can be stored. After receiving the user's manipulation with respect to the audio/video file, the location of the file can be located, and the contents or the associated properties of the file can be obtained. As a result, the menu metadata obtained by the analysis can be used in subsequent comparisons.

In block S103, an instruction of an interaction menu is analyzed to determine the menu metadata corresponding to the instruction of the interaction menu, wherein the interaction menu includes a multi-level menu.

The interactive menu is also a part of the encapsulation of the audio/video file. One audio/video file can include more than one interactive menu. Each interactive menu contains an action correspondence table such as click operation+click area location, whether to play a certain title, as well as the location and the data size of the title in the file, etc.

The interactive menu includes a multi-level menu, which means that the menu further includes a next-level menu.

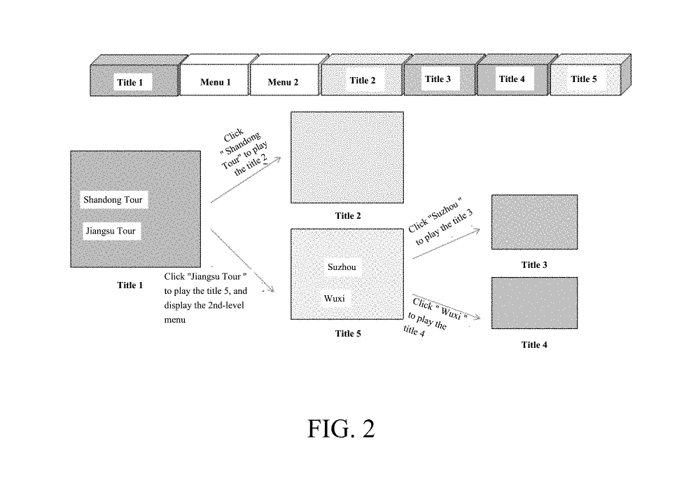

For instance, as shown in FIG. 2, one audio/video file includes 5 titles and 2 menus, wherein the menu 2 is a 2nd-level menu of the menu 1. When playing the title 1, the menu 1 is displayed. When the user clicks on “Shandong Tour”, the title 2 is played. When the user clicks on “Jiangsu Tour”, the title 5 is played, while the 2nd-level menu, i.e., the menu 2, is displayed. When the user clicks on “Suzhou”, the title 3 is played. When the user clicks on “Wuxi”, the title 4 is played.

The interactive menu is displayed in an interface of the upper application, which can be used to provide interaction to the user, so that the user can select the corresponding audio/video title. When the user makes a selection, an instruction of the interactive menu is submitted, and the instruction of the interactive menu is analyzed to determine the menu metadata corresponding to the instruction of the interactive menu.

In block S104, whether to switch to and play the audio/video titles and/or subtitles mapped by the instruction of the interaction menu is determined basing on the menu metadata corresponding to the instruction of the interaction menu.

When analyzing the audio/video file, all the menu metadata in the audio/video file is stored, and the menu metadata corresponding to the instruction of the interaction menu is compared. If the menu metadata corresponding to the instruction of the interaction menu is equivalent to the menu metadata of the most recently played audio/video title and/or subtitle, it is unnecessary to switch and can continue to replay. If the menu metadata corresponding to the instruction of the interaction menu is different from the menu metadata of the most recently played audio/video title and/or subtitle, it needs to switch and play the audio/video titles and/or subtitles mapped by the instructions of the interactive menu.

In this embodiment, the file type of an audio/video file is determined, and a message is sent to notify an upper layer application; the audio/video file is analyzed according to the file type of the audio/video file to obtain a menu metadata of the audio/video file, and the menu metadata is stored; an instruction of an interaction menu is analyzed to determine the menu metadata corresponding to the instruction of the interaction menu, wherein the interaction menu includes a multi-level menu; and whether to switch to and play the audio/video titles and/or subtitles mapped by the instruction of the interaction menu is determined basing on the menu metadata corresponding to the instruction of the interaction menu. Through the menu metadata of the instruction of the interactive menu and the menu metadata corresponding to the instruction of the multi-level interaction menu which are obtained by the analyses, whether to switch to and play the audio/video titles and/or subtitles mapped by the instruction of the interaction menu is determined. In this way, audio/video files including multiple independent audio/video titles and/or subtitles can be played according to a user's selection under the GStreamer multimedia playback framework.

In one embodiment, analyzing the menu metadata corresponding to the instruction of the interaction menu may specifically include: analyzing a user interface coordinate information corresponding to the instruction of the interaction menu to obtain a user interface coordinate, converting the user interface coordinate into a relative coordinate of the audio/video titles and/or the subtitles, and determining the menu metadata corresponding to the instruction of the interaction menu.

For instance, when the user clicks a button on the menu, then:

A. Determines whether a button is clicked according to the user interface coordinates of the click, if yes, determines the specific button had been clicked.

B. Converts the user interface coordinates of the button into a relative coordinate of the audio/video titles and/or the subtitles, finds the menu metadata, an then the menu metadata of the title corresponding to the button clicked by the user can be determined.

Of course, it is possible to number each item of the content (i.e., the content of the button corresponding to the above-mentioned example) in the menu, such that the menu metadata corresponding to the user's selection can be directly obtained when the user inputs a number, and then whether to switch to and play the audio/video titles and/or subtitles mapped by the instruction of the interaction menu can be determined. In actual applications, since the key points of how to analyze the menu metadata corresponding to the instruction of the interactive menu are the encapsulation format of the audio/video file, the corresponding menu metadata, and the way of display, the corresponding analysis method is also varied.

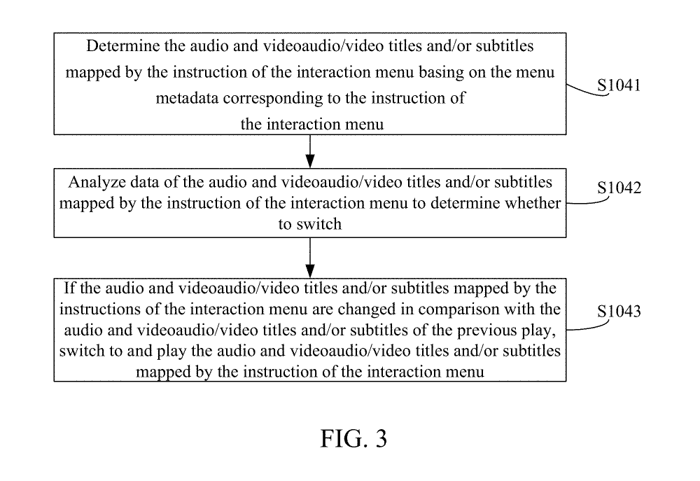

Referring to FIG. 3, the method in block S104 may specifically include block S1041, block S1042, and block S1043.

In block S1041, the audio/video chapters and/or subtitles mapped by the instruction of the interaction menu is determined basing on the menu metadata corresponding to the instruction of the interaction menu.

In block S1042, data of the audio/video titles and/or subtitles mapped by the instruction of the interaction menu is analyzed to determine whether to switch.

In block S1043, the audio/video titles and/or subtitles mapped by the instruction of the interaction menu is played after switching, if the audio/video titles and/or subtitles mapped by the instructions of the interaction menu are changed in comparison with the audio/video titles and/or subtitles of the previous play.

Through the above-mentioned method, it is possible to determine whether to switch to and play the audio/video titles and/or subtitles mapped by the instruction of the interactive menu.

In the same way, depending on the encapsulation format of the audio/video file, the corresponding menu metadata, and the way of display, the specific implementation of block S104 may be varied, which is no longer enumerated herein.

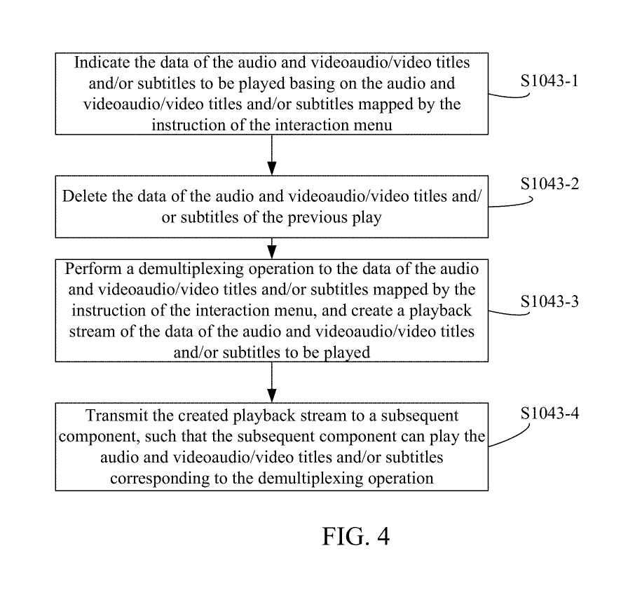

Furthermore, referring to FIG. 4, in block S1043, the steps of switching to and playing the audio/video titles and/or subtitles mapped by the instruction of the interactive menu may specifically include block S1041-1, block S1041-2, block S1041-3, and block S1041-4.

In block S1041-1, the data of the audio/video titles and/or subtitles to be played is indicated basing on the audio/video titles and/or subtitles mapped by the instruction of the interaction menu.

In block S1041-2, the data of the audio/video titles and/or subtitles of the previous play are deleted.

In block S1041-3, a demultiplexing operation to the data of the audio/video titles and/or subtitles mapped by the instruction of the interaction menu is performed, and a playback stream of the data of the audio/video titles and/or subtitles to be played is created.

In block S1041-4, the created playback stream is transmitted to a subsequent component, such that the subsequent component can play the audio/video titles and/or subtitles corresponding to the demultiplexing operation.

Through the above-mentioned method, it is possible to easily realize switching to and playing the audio/video titles and/or subtitles mapped by the instruction of the interaction menu without a large change.

In one embodiment, in block S101, determining the file type of the audio/video file includes determining whether the file type of the audio/video file is the DivXMenu file type.

In addition to package audio/video multimedia contents based on the standard AVI file, the DivX company further provides an additional expansion including a video menu+multiple audio/video titles/subtitles. The video menu can be used to provide interaction to the user, thereby selecting the corresponding audio/video title. A file packaged through this method is a DivXMenu audio/video file, which includes interactive menus, multiple subtitles, multiple tracks, multiple videos, titles, menu metadata, etc. A title contains audio, video, subtitle coding content, which compose a complete title for playback. The title of a DivXMenu file can be considered as a simple AVI file.

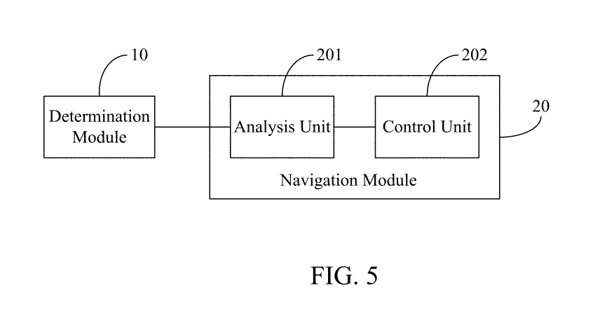

Referring to FIG. 5, a schematic diagram of the structure of an embodiment of an audio/video file playback apparatus of the present disclosure is depicted. The playback apparatus of this embodiment can perform the steps in the above-method method. The details of the relevant contents can be referred to in the above-mentioned method, which will not be repeated herein. Wherein, the audio/video file played by the playback apparatus includes a plurality of independent audio/video titles and/or subtitles, and the audio/video file is played based on a GStreamer multimedia playback framework.

The apparatus includes a determination module 10 and a navigation module 20.

The determination module 10 is utilized to determine the file type of the audio/video file and send a message to notify an upper layer application.

The navigation module 20 is coupled to the determination module 10, which is utilized to control the playback of the audio/video file based on the GStreamer multimedia playback framework. The navigation module 20 includes an analysis unit 201 and a control unit 202.

The analysis unit 201 is utilized to analyze the audio/video file according to the file type of the audio/video file to obtain a menu metadata of the audio/video file and storing the menu metadata, as well as receive an instruction of an interaction menu to determine the menu metadata corresponding to the instruction of the interaction menu, wherein the interaction menu includes a multi-level menu.

The control unit 202 is utilized to determine whether to switch to and play the audio/video titles and/or subtitles mapped by the instruction of the interaction menu basing on the menu metadata corresponding to the instruction of the interaction menu.

In this embodiment, the file type of an audio/video file is determined, and a message is sent to notify an upper layer application; the audio/video file is analyzed according to the file type of the audio/video file to obtain a menu metadata of the audio/video file, and the menu metadata is stored, an instruction of an interaction menu is analyzed to determine the menu metadata corresponding to the instruction of the interaction menu, wherein the interaction menu includes a multi-level menu; and whether to switch to and play the audio/video titles and/or subtitles mapped by the instruction of the interaction menu is determined basing on the menu metadata corresponding to the instruction of the interaction menu. Through the menu metadata of the instruction of the interactive menu and the menu metadata corresponding to the instruction of the multi-level interaction menu obtained by the analyses, whether to switch to and play the audio/video titles and/or subtitles mapped by the instruction of the interaction menu is determined. In this way, audio/video files including multiple independent audio/video titles and/or subtitles can be played according to a user's selection under the GStreamer multimedia playback framework.

In one embodiment, the analysis unit 201 is utilized to analyze a user interface coordinate information corresponding to the instruction of the interaction menu to obtain a user interface coordinate, convert the user interface coordinate into a relative coordinate of the audio/video titles and/or the subtitles, and determine the menu metadata corresponding to the instruction of the interaction menu.

In one embodiment, the control unit 202 is further utilized to determine the audio/video titles and/or subtitles mapped by the instruction of the interaction menu basing on the menu metadata corresponding to the instruction of the interaction menu, analyze data of the audio/video titles and/or subtitles mapped by the instruction of the interaction menu to determine whether to switch, and switch to and play the audio/video titles and/or subtitles mapped by the instruction of the interaction menu, if the audio/video titles and/or subtitles mapped by the instructions of the interaction menu are changed in comparison with the audio/video titles and/or subtitles of the previous play.

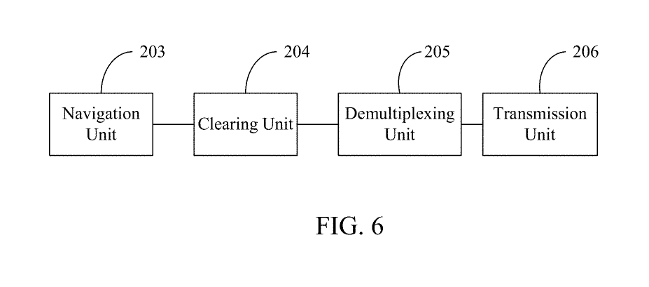

In one embodiment, referring to FIG. 6, the navigation module 20 further includes: a navigation unit 203, a clearing unit 204, a demultiplexing unit 205, and a transmission unit 206.

The navigation unit 203 is utilized to indicate the data of the audio/video titles and/or subtitles to be played basing on the audio/video titles and/or subtitles mapped by the instruction of the interaction menu.

The clearing unit 204 is utilized to delete the data of the audio/video titles and/or subtitles of the previous play.

The demultiplexing unit 205 is utilized to perform a demultiplexing operation to the data of the audio/video titles and/or subtitles mapped by the instruction of the interaction menu, and create a playback stream of the data of the audio/video titles and/or subtitles to be played.

The transmission unit 206 is utilized to transmit the created playback stream to a subsequent component, such that the subsequent component can play the audio/video titles and/or subtitles corresponding to the demultiplexing operation.

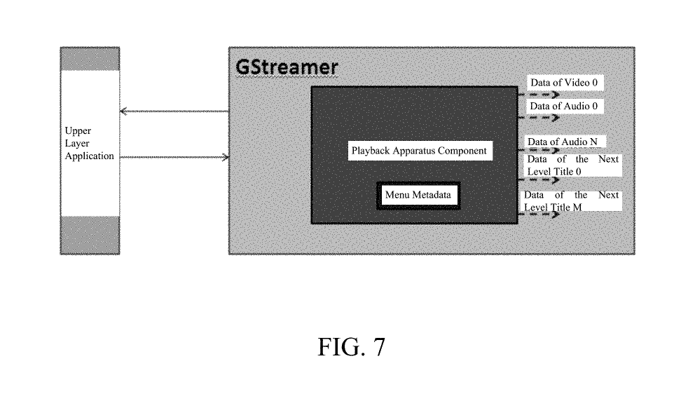

In one embodiment, the playback apparatus is individually integrated as a new component in the GStreamer multimedia playback framework. Referring to FIG. 7, in one embodiment, the playback apparatus is integrated as a component in the GStreamer multimedia framework. The playback apparatus component has the functions of the existing AviDemux in the navigator and the GStreamer multimedia framework.

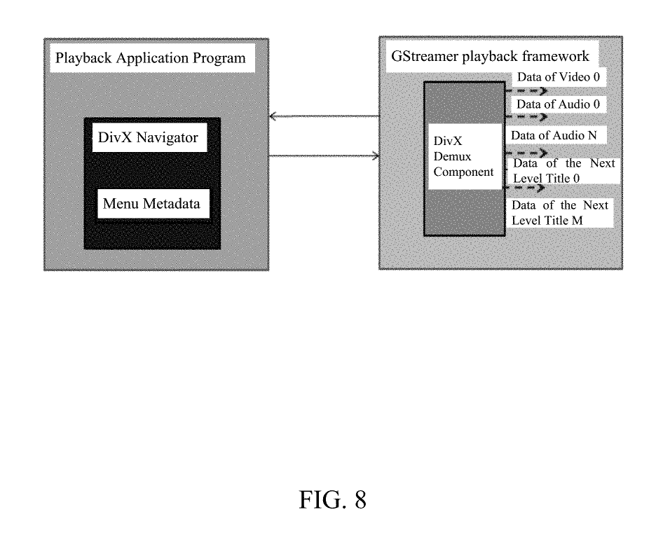

In one embodiment, the playback apparatus is integrated between a playback application program and the GStreamer multimedia playback framework or integrated in a playback application program. For instance, referring to FIG. 8, in a particular embodiment, the navigator function of the playback apparatus can be placed in the GStreamer multimedia framework (e.g., in a playback application program, as shown in FIG. 8), or placed in a middle layer between the playback application program and the GStreamer multimedia framework.

In one embodiment, the determination module 10 is further utilized to determine whether the file type of the audio/video file is the DivXMenu file type.

The above description depicts merely some exemplary embodiments of the disclosure, but is meant to limit the scope of the disclosure. Any equivalent structure or flow transformations made to the disclosure, or any direct or indirect applications of the disclosure on other related fields, shall all be covered within the protection of the disclosure.

What is claimed is:

1. A method for playing an audio/video file, wherein the audio/video file comprises at least one of a plurality of independent audio/video titles as well as a plurality of independent subtitles, the audio/video file is played based on a GStreamer multimedia playback framework, the method comprising:
determining the file type of the audio/video file and sending a message to notify an upper layer application;
analyzing the audio/video file according to the file type of the audio/video file to obtain a menu metadata of the audio/video file and storing the menu metadata;
analyzing an instruction of an interaction menu to determine the menu metadata corresponding to the instruction of the interaction menu, wherein the interaction menu comprises a multi-level menu; and
determining whether to switch to and play the audio/video titles and/or subtitles mapped by the instruction of the interaction menu basing on the menu metadata corresponding to the instruction of the interaction menu.

2. The method of claim 1, wherein analyzing the menu metadata corresponding to the instruction of the interaction menu comprises:
analyzing a user interface coordinate information corresponding to the instruction of the interaction menu to obtain a user interface coordinate, converting the user interface coordinate into a relative coordinate of at least one of the audio/video titles as well as the subtitles, and determining the menu metadata corresponding to the instruction of the interaction menu.

3. The method of claim 2, wherein determining whether to switch to and play at least one of the audio/video titles as well as the subtitles mapped by the instruction of the interaction menu basing on the menu metadata corresponding to the instruction of the interaction menu comprises:
determining at least one of the audio/video titles as well as the subtitles mapped by the instruction of the interaction menu basing on the menu metadata corresponding to the instruction of the interaction menu;
analyzing data of at least one of the audio/video titles as well as the subtitles mapped by the instruction of the interaction menu to determine whether to switch; and
if at least one of the audio/video titles as well as the subtitles mapped by the instructions of the interaction menu are changed in comparison with at least one of the audio/video titles as well as the subtitles of the previous play, switching to and playing at least one of the audio/video titles as well as the subtitles mapped by the instruction of the interaction menu.

4. The method of claim 3, wherein switch to and play at least one of the audio/video titles as well as the subtitles mapped by the instruction of the interaction menu further comprises:
indicating the data of at least one of the audio/video titles as well as the subtitles to be played basing on at least one of the audio/video titles as well as the subtitles mapped by the instruction of the interaction menu;
deleting the data of at least one of the audio/video titles as well as the subtitles of the previous play,
performing a demultiplexing operation to the data of the audio/video titles and/or subtitles mapped by the instruction of the interaction menu, and creating a playback stream of the data of at least one of the audio/video titles as well as the subtitles to be played; and
transmitting the created playback stream to a subsequent component, such that the subsequent component can play at least one of the audio/video titles as well as the subtitles corresponding to the demultiplexing operation.

5. The method of claim 1, wherein determining the file type of the audio/video file comprises:
determining whether the file type of the audio/video file is the DivXMenu file type.

6. An audio/video file playback apparatus, wherein an audio/video file played by the playback apparatus comprises at least one of a plurality of independent audio/video titles as well as a plurality of independent subtitles, the audio/video file is played based on a GStreamer multimedia playback framework, the apparatus comprising:
a determination module configured to determine the file type of the audio/video file and sending a message to notify an upper layer application; and
a navigation module coupled to the determination module and configured to control the playback of the audio/video file based on the GStreamer multimedia playback framework, comprising:
an analysis unit configured to analyze the audio/video file according to the file type of the audio/video file to obtain a menu metadata of the audio/video file and store the menu metadata, as well as receive an instruction of an interaction menu to determine the menu metadata corresponding to the instruction of the interaction menu, wherein the interaction menu comprises a multi-level menu; and
a control unit configured to determine whether to switch to and play at least one of the audio/video titles as well as the subtitles mapped by the instruction of the interaction menu basing on the menu metadata corresponding to the instruction of the interaction menu.

7. The playback apparatus of claim 6, wherein the analysis unit is configured to analyze a user interface coordinate information corresponding to the instruction of the interaction menu to obtain a user interface coordinate, convert the user interface coordinate into a relative coordinate of the audio/video titles and/or the subtitles, and determine the menu metadata corresponding to the instruction of the interaction menu.

8. The playback apparatus of claim 7, wherein the control unit is further configured to determine at least one of the audio/video titles as well as the subtitles mapped by the instruction of the interaction menu basing on the menu metadata corresponding to the instruction of the interaction menu, analyze data of at least one of the audio/video titles as well as the subtitles mapped by the instruction of the interaction menu to determine whether to switch, and if at least one of the audio/video titles as well as the subtitles mapped by the instructions of the interaction menu are changed in comparison with at least one of the audio/video titles as well as the subtitles of the previous play, switch to and playing at least one of the audio/video titles as well as the subtitles mapped by the instruction of the interaction menu.

9. The playback apparatus of claim 8, wherein the navigation module further comprises:
a navigation unit configured to indicate the data of at least one of the audio/video titles as well as the subtitles to be played basing on at least one of the audio/video titles as well as the subtitles mapped by the instruction of the interaction menu;
a clearing unit configured to delete the data of at least one of the audio/video titles as well as the subtitles of the previous play;
a demultiplexing unit configured to perform a demultiplexing operation to the data of at least one of the audio/video titles as well as the subtitles mapped by the instruction of the interaction menu, and create a playback stream of the data of at least one of the audio/video titles as well as the subtitles to be played; and
a transmission unit configured to transmit the created playback stream to a subsequent component, such that the subsequent component can play at least one of the audio/video titles as well as the subtitles corresponding to the demultiplexing operation.

10. The playback apparatus of claim 6, wherein the playback apparatus is individually integrated as a new component in the GStreamer multimedia playback framework.

11. The playback apparatus of claim 6, wherein the playback apparatus is integrated between a playback application program and the GStreamer multimedia playback framework or integrated in a playback application program.

12. The playback apparatus of claim 6, wherein the determination module is further configured to determine whether the file type of the audio/video file is the DivXMenu file type.
